(19) United States
(12) Patent Application Publication
(10) Pub. No.: US 2007/0288540 A1
(43) Pub. Date: Dec. 13, 2007

(54) Sorting points into neighborhoods (spin)

(75) Inventors: Ilan Tsafrir, London (GB); Dafna Tsafrir, London (GB); Eytan Domany, Rechovot (IL)

Correspondence Address: Martin D Moynihan;Prtsi Inc, P O Box 16446, Arlington, VA, 22215, US

(73) Assignee: Yeda Research And Develpment Co Ltd., Rechovot (IL)

(21) Appl. No.: 10/591,445

(22) PCT Filed:
(86) PCT No.: PCT/IL05/00241

Related U.S. Application Data
(60) Provisional application No. 60/548,182, filed on Mar. 1, 2004.

(51) Int. Cl. G06F 17/10; G06F 7/32

(52) U.S. Cl. 708/300

(57) ABSTRACT

A method for an unsupervised analysis of data according to a reordered distance matrix. According to preferred embodiments thereof, the present invention is useful for large scale multidimensional data, more preferably data having at least four dimensions. The present invention is also preferably used for data comprising a plurality of objects characterized by continuous variables, for example variables having a continuum of possible values rather than a plurality of discrete values.

### FIELD OF THE INVENTION

The present invention is of a method for analyzing and visualizing large collections of data.

### BACKGROUND OF THE INVENTION

Exploratory data analysis is critical in a broad range of research areas, where large collections of data need to be meaningfully arranged and presented. Indeed, a major challenge in the analysis of large-scale multidimensional data is effective organization and visualization. Graphically structured presentation can greatly aid humans in data mining: a clear and interactive display may reveal subtle structure and relationships, and assist in tracking down elusive connections.

### SUMMARY OF THE INVENTION

The background art does not teach or suggest an efficient, intuitive tool for automated analysis and visualization, which may optionally be performed with little or no manual intervention. The background art also does not teach or suggest reorganization of distance matrices using the characteristics of the distances themselves. The background art does not teach how to read the properties and relationships of the data from the reordered distance matrix.

The present invention overcomes these deficiencies of the background art by providing a method for an unsupervised analysis of data according to a reordered distance matrix. According to preferred embodiments thereof, the present invention is useful for large scale multidimensional data, more preferably data having at least four dimensions. The present invention is also preferably used for data comprising a plurality of objects characterized by continuous variables, for example variables having a continuum of possible values rather than a plurality of discrete values. It should be noted that single object featuring a plurality of points would also be considered a plurality of objects with regard to the present invention.

According to preferred embodiments, the present invention provides an analysis method termed herein SPIN, a novel method for the organization and visualization of data, implemented in a simple tool. SPIN utilizes traits of distance matrices to sort objects in a natural ordering that highlights the underlying structure of the original, multidimensional data. The shape of the distribution of objects and/or of the objects themselves, and relationships between objects can be inferred from the reordered distance matrix generated by SPIN. As an unsupervised analysis tool, SPIN does not rely on any external labels, but rather explores the inherent characteristics of the data. In the analysis of high-throughput biological experiments, discretely-labeled data, such as clinical labels of ‘sick’ versus ‘healthy’, is traditionally organized by various clustering approaches. However, when the objects are characterized by continuous variables, e.g. survival intervals of patients or expression levels of genes, any sharp separation into distinct clusters will be rather arbitrary. Thus, a different organization approach, one which emphasizes ordering rather than grouping, could be more relevant.

This work focuses on finding a one-dimensional ordering of a set composed of n data points, and to present as output the matching (2-dimensional) n by n distance matrix D. An element Dᵢⱼ of D represents the dissimilarity between objects i and j. Our aim is to find a permutation of the data points, such that the correspondingly reordered distance matrix reveals the underlying structure of the data, utilizing the human ability to readily recognize patterns in color images [1]. Sorting Points Into Neighborhoods (SPIN), generates a one-dimensional ordering of the objects and presents the reordered distance matrix in an intuitive color coded image that allows the observer to infer the underlying structure of the data. SPE7 is especially suitable for analyzing high-throughput biological experiments, such as gene array experiments, where results are typically summarized in an expression matrix, in which each element denotes the expression level of a particular gene in a specific sample [1]. In this context two types of distance matrices can be produced: the distances between all pairs of samples can be calculated based on their expression levels over the. measured genes, and the distance between all pairs of genes can be measured in the sample dimensions [2]. The sorted distance matrix generated by SPIN is particularly useful in time-series experiments, where an elongated cluster represents the temporal evolution of a particular biological module, such as cell-cycle progression. Another example where the shape revealed by SPIN has a clear biological interpretation comes from cancer research where samples are often composed of mixtures of cells: for instance, colon tissue samples isolated from liver metastases arrayed into an elongated, ellipsoid cluster [3]. The genes that induced the elongation were characteristic of liver, suggesting that this pattern reflects a mixture of the metastasis samples with cells originating from the liver.

Among the many advantages of the present invention is that the method provides an efficient and intuitive way to read the properties and relationships of the data from the reordered distance matrix. Contact maps of proteins have been used to discover secondary structure, but they posses an inherent ordering (according to the primary sequence). Therefore, the present invention represents the first method to be able to discover such properties and relationships without any inherent ordering (that is to say, pre-ordering) of the data.

### BRIEF DESCRIPTION OF THE DRAWINGS

The invention herein described, by way of example only, with reference to the accompanying drawings, wherein:

FIG. 1 shows an exemplary analysis of a set of points that form a single object in multidimensional space;

FIG. 2 shows analysis of a data set composed of several distinct clusters;

FIG. 3 illustrates SPIN's ability to deal with complex objects embedded in high dimensional space;

FIG. 4 shows a schematic illustration of the side-by-side algorithm according to the present invention;

FIG. 5 is an exemplary pseudocode of an exemplary side-by-side algorithm according to the present invention;

FIG. 6 shows the end result of applying Side-to-side to data composed of 960 points in 9 spherical clusters in 3D;

FIG. 7 is an exemplary pseudocode of an exemplary neighborhood algorithm according to the present invention;

FIG. 8 shows a comparison between side-by-side and neighborhood algorithms;

FIG. 9 shows the results of analyzing yeast data with the. method according to the present invention

FIG. 10 shows the results of analyzing leukemia data with the method according to the present invention;

FIG. 11a-d shows the results of using the method according to the present invention for machine vision;

FIG. 12a-g shows the results of analyzing colon cancer data with the method according to the present invention.

### DESCRIPTION OF PREFERRED EMBODIMENTS

The present invention is of a method for an unsupervised analysis of data according to a reordered distance matrix. According to preferred embodiments thereof, the present invention is useful for large scale multidimensional data, more preferably data having at least four dimensions. The present invention is also preferably used for data comprising a plurality of objects characterized by continuous variables, for example variables having a continuum of possible values rather than a plurality of discrete values.

According to preferred embodiments, the present invention provides an analysis method termed herein SPIN, a novel method for the organization and visualization of data, implemented in a simple tool.

The input to SPIN is a distance matrix, and its output is a reordered distance matrix, obtained by permuting the N objects. Currently two different algorithms, based on two complementary intuitions, are implemented. However, optionally and preferably substantially any algorithm may be employed with the method of the present invention. The two algorithms utilize two distinct (and sometimes competing) desirable properties of properly ordered distance matrices: first, in many cases the values in the upper rows of a well-ordered distance matrix tend to increase with the column index, while the values in the bottom rows have the opposite inclination. In other words, the slope of the linear regression of the values in a row is a decreasing function of the row's index in the sorted matrix. The first algorithm, named Side-to-side, simply generates such a pattern. The second property is that the region near the main diagonal tends to have smaller dissimilarity values, i.e. a “good” ordering locates points next to their neighbors in the full high-dimensional space. The second algorithm, called neighborhood, tries to create such an arrangement by ensuring that distant data points in the multi-dimensional space are not placed close to each other in the linear ordering.

Although both algorithms achieve a one dimensional ordering of the data set, the final resulting permutations are different in the following sense: Side-to-side tries to capture a particular pattern in the image of the distance matrix. As a result, points that are placed far apart in the linear ordering are also distant in the full high-dimensional space. Neighborhood, on the other hand, tries to make sure that neighboring points in the linear ordering are close to each other in the high dimensional space. This subtle distinction in emphasis may lead to substantial difference in the results, as illustrated for points that form a ring, described in greater detail below. A ring is a simple example where these two criteria are mutually exclusive. Neighborhood orders the points around the circumference of the ring. Due to the cyclic symmetry of the ring, the end points in this ordering are very close to one another in the true high dimensional space. This does not conform to the pattern that Side-to-side enforces.

In general, Side-to-side is simpler, faster, and seems to converge quickly for all the examples currently examined. It has no parameters, so the final ordering depends only on the initial permutation. Neighborhood, on the other hand, seems to have the potential to generate superior results in several cases. However, it does not always converge, and occasionally gets mired in obviously local stationary permutations. The size of the neighborhood, σ, determines the typical scales of objects that are revealed: small values of σ tend to break large clusters into small “clumps”; conversely, large σ values tend to merge neighboring clusters.

Several examples are given below in which the structure uncovered by SPIN has a clear biological interpretation, such as the cyclic nature of cell-cycle progression, visualized in a ring conformation. In another example the tissue composition of tested samples is captured by their relative placement in an ordered elongated cluster, formed in the space of tissue specific genes. Another example is related to machine or robot vision. Therefore, the method of the present invention has general applicability, which makes it relevant to diverse scientific disciplines and/or technologies.

Example 1 demonstrates the concepts and the intuitions that underlie the method according to the present invention, and shows how to infer structure characteristics from the sorted distance matrix. Example 2 provides a formal description of a preferred illustrative embodiment of the method. Examples 3-4 feature several applications to real data, where the shapes uncovered by SPIN are directly interpretable in biological terms. Example 5 relates to data for machine or robot vision.

Section 1: General Description of an Illustrative Method

### EXAMPLE 1

### Pedagogical Examples

A properly ordered distance matrix is indicative of the shape of a set of points. All the data sets presented in this article were ordered using SPIN, starting from a random initial permutation. The distance matrices were generated using the Euclidean distance measure, though our methodology can be applied to many dissimilarity metrics. The color of element Dᵢⱼ reflects the relative distance between points i and j, where blue (red) denotes small (large) distances, respectively.

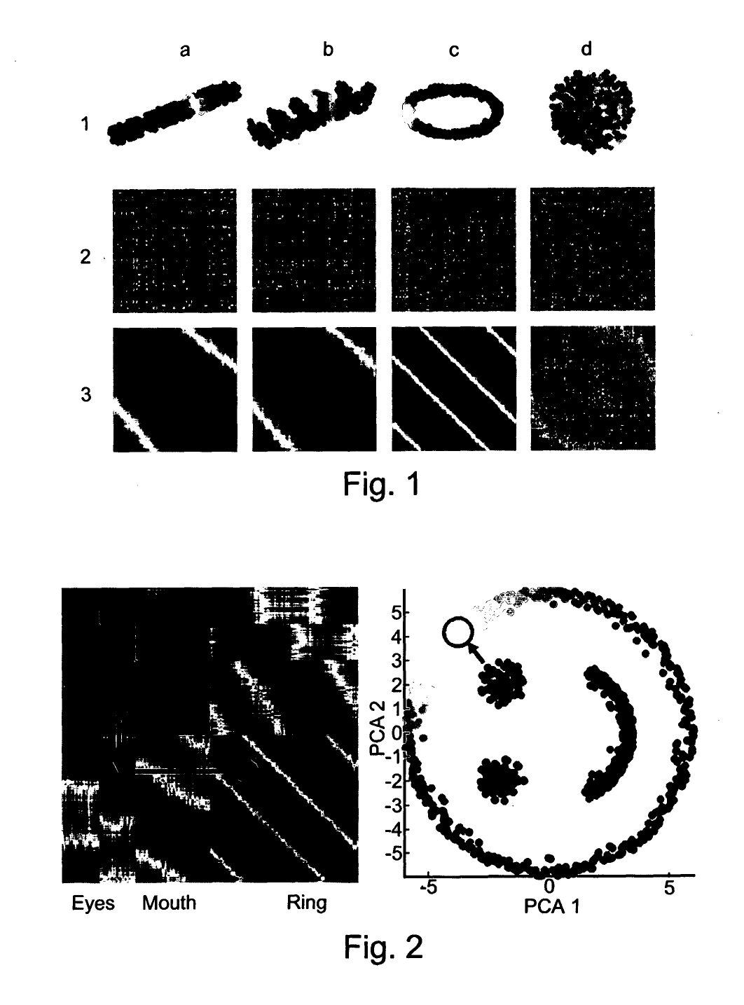

For explaining the SPIN method, we first address a set of points that form a single object in multidimensional space. The top row (1) of FIG. 1 depicts the placement of n=500 points in d=3 dimensions, for a few toy data sets; below each object (row 2) we show the initial, unordered, distance matrix, while in the bottom row we present the corresponding sorted distance matrix. Although both the ordered and unordered matrices contain exactly the same elements, the sorted distance matrix allows a human observer to deduce structural information. The colors of the objects in the top row represent the linear ordering of the points, where the first point is dark blue ranging to the last point in dark red. This is the same order that SPIN imposed on the distance matrix, i.e. the first row and first column contain the distances from the first point (the one colored dark blue in the PCA image) to all other points. (a) An elongated shape, in this case a cylinder, displays a clear gradient of distances that increase as one moves away from the main diagonal. (b) This gradient holds even if the center-line of the elongated shape is curved, as demonstrated by a helical structure. (c) A ring of points is characterized by a cyclic pattern, with small distances (blue) at the corners. (d) Finally, a spherical cluster with no significant elongation has a diffuse texture. As a rule, the smoothness of the texture in the image of the distance matrix is a function of the elongation of the cluster.

For example, consider points uniformly distributed within a cylinder, as presented in FIG. 1a1. The first stage in our methodology is to generate a distance matrix for a set of points. The initial, unordered, distance matrix (FIG. 1a2) is not easy to interpret, but after rearrangement in SPIN the sorted image is highly informative (FIG. 1a3). In this example SPIN orders the points from one end of the cylinder to the other, so that the correspondingly reorganized distance matrix has a characteristic pattern. The area close to the main diagonal of the sorted matrix contains only short distances (blue color), with a clear gradient of increasing distances (colors vary from blues to reds) as one moves away from the main diagonal. In fact, this signature characterizes any significantly elongated object, as can be seen in the case of a coil (FIG. 1b). This colored pattern is the essence of SPIN: neighboring points in the one dimensional ordering produced by SPIN are also close to each other in the original multidimensional space. Hence, once a distance matrix is sorted in SPIN, simply viewing the resulting colored image allows the user to deduce the object's features.

Another simple structure, a ring (see FIG. 1c1), is also characterized by a definitive pattern, once the points are properly ordered. In the sorted image (FIG. 1c3) the blue region around the main diagonal indicates that SPIN sorts the points around the circumference of the ring, placing points that are close in the original space as neighbors. The distances in the sorted matrix are cyclic with regard to their position relative to the main diagonal. This can be understood by considering the organization of the ring: starting from any arbitrary point and going around the ring, the distance of the current point to the initial point increases monotonously (colors change from blue to red) until the diametrically opposing point is reached. At this stage the distances begin to decrease (colors go back to blue), as we approach the point of origin from the other side.

Given more complex data, the ordered distance matrix suggested by SPIN can capture the over all layout of a compound structure, as well as the local conformation of various components. In FIG. 2 we analyze a data set composed of several distinct clusters. The sorted distance matrix that SPIN produces allows one to study the local shape of each cluster in the data, as well as the global relationships between clusters. In this example there are four major clusters, two of which are tight spherical clusters (eyes) that appear as dark blue squares on the main diagonal. From the light blue color of the squares between them we can deduce that the eyes are relatively close to each other, i.e. we can infer their relative placement. The next cluster (smile) has a gradient of colors, from dark blue on the main diagonal to light blue at the corners. As explained above, this indicates an elongated structure. The fourth cluster has a sharp gradient of colors, that cycles through the entire spectrum. As explained in FIG. 1, such a pattern in the distance matrix indicates a cyclic shape, in this case a ring. The fact that the distance between opposing points on the ring is the largest in the data set (i.e. the darkest red in the distance matrix) indicates that the ring engulfs all other points.

This toy data set is “composed of 800 points in 10-dimensions. The complex object was originally generated in 3-D, and then seven additional dimensions of noise (uniformly distributed between −1 and 1) were added. The right image of FIG. 2 shows the projection of the points onto the first and second PCA plane (two spheres and a curved cylinder within a ring), and the distance matrix on the left is sorted accordingly. From this organized matrix one can easily infer the shapes of the four clusters and their relative placement. For example the position on the ring closest to the top eye is denoted by a black circle. This can be inferred from the sorted matrix by locating the blue patch in the region corresponding to the relationship between the eye and the ring, as shown by the arrows.

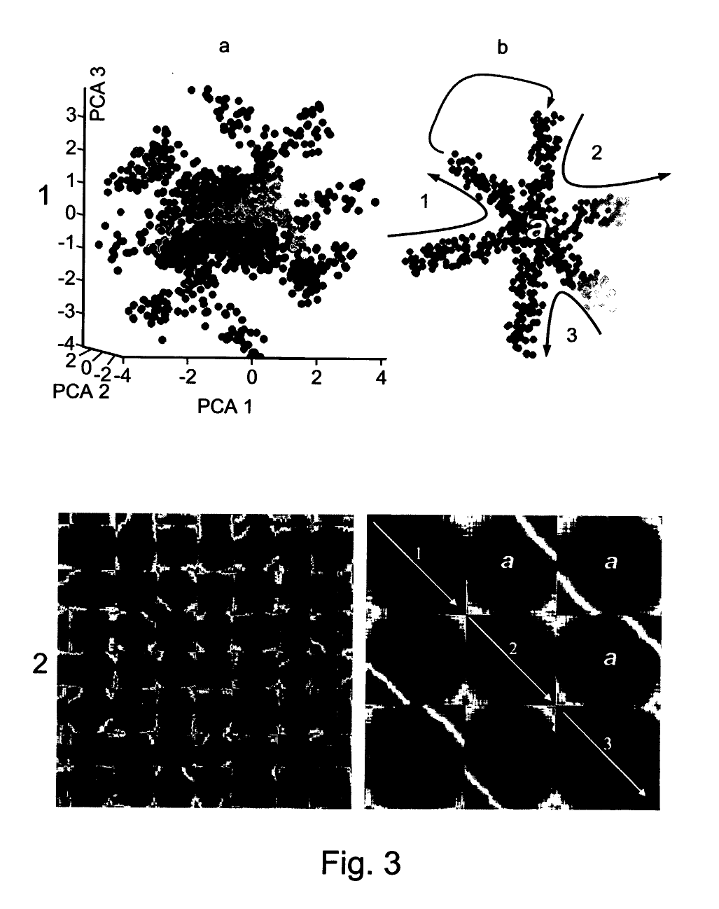

The next example illustrates SPIN's ability to deal with complex objects embedded in high dimensional space: FIG. 3a1 shows a 3-D projection of points constituting a set of seven intersecting cylinders, twisted in d=7 dimensions. On the left is a set of seven orthogonal intersecting cylinders, comprised of 1400 points in seven dimensions. The rods were twisted by rotation with angles that increase linearly with the distance from the origin. (a1) The points displayed in the first three PCA, colored according to their placement in SPIN. In this example the coloring is crucial for making sense out of a complex image. (a2) The correspondingly sorted distance matrix is shown. The right column shows a simplified version having 600 points composing three straight intersecting rods in three dimensions. (b1) The actual placement of the points is shown, where the numbered arrows illustrate the order imposed by SPIN. (b2). The correspondingly sorted distance matrix is shown. The region of the intersection creates blue patches in the off-diagonal regions of the distance matrix (denoted by a).

In the distance matrix in FIG. 3a2 each rod is an elongated structure along the main diagonal. As explained above, the relationships between the seven regions can be deduced from the shape of the off-diagonal regions in the organized distance matrix, and indeed the fact that the rods share a common nexus is reflected by a grid of blue patches. This example illustrates a case where SPIN highlights a simple characteristic of a high-dimensional object that is not immediately made evident by projection onto a smaller dimensional space. In order to assist the reader in understanding this example, the right column FIG. 3 is a simplified version: three straight rods in three-dimensions. The arrows follow the order of the points, going from the outer edge of a rod, through the center then out along a second rod, jumping to the outer edge of the third rod etc.

### EXAMPLE 2

### Illustrative Method

This Example provides an illustrative method according to the present invention, as a description of a preferred embodiment thereof, the SPIN method.

The input to SPIN is a distance matrix D_{n×n} calculated for a data set composed of n points, and its output is a reordered distance matrix, obtained by permuting the n objects according to a particular permutation PεSₙ (the permutation group of n points). We denote by P also the permutation matrix associated with p.

In order to find criteria for a good ordering, we studied several simple objects characterized by an inherent natural ordering (See FIG. 1a-c). Having observed such ordered distance matrices, we noticed two distinct and sometimes competing properties. First, in many cases the values in the upper rows of a well-ordered distance matrix tend to increase with the column index, while the values in the bottom rows have the opposite inclination. The second property is that the region near the main diagonal tends to have smaller dissimilarity values, i.e. points are positioned next to their neighbors in the full high-dimensional space. These two properties ‘Side-to-Side’ and ‘Neighborhood’, respectively, and are related to two algorithms of the same name.

These attributes can be mathematically formulated by introducing an energy function F≡F_{D}:Sₙ→ [symbol] quantifying the fitness of every matrix ordering. Thus, the ordering problem becomes finding the permutation p minimizing F. We emphasize that there is no unique ‘correct’ choice of F, as different energy functions may potentially reveal different aspects of the data, thus enabling study of diverse properties, as will be demonstrated later.

The two aforementioned desired features of an ordered distance matrix can be represented by the following energy functions:

1. Side-to-Side (STS): Let X be a strictly increasing (column) vector. Set F(P)=X^{T}PDP^{X}.

2. Neighborhood: Let W be a symmetric weight matrix concentrated in a region, determined by a parameter σ around its main diagonal. Set

$$F ( P ) = tr ( {PDP}^{T} W ) = {\sum }_{i , j = 1}^{n} {W}_{ij} {D}_{P ( i ) P ( j )} ,$$

where tr denotes the matrix trace.

Interestingly, the problems of minimizing the two choices of F mentioned above are special cases of a more general optimization problem, known as the Quadratic Assignment Problem (QAP), introduced by [4]. The QAP formulation is as follows: Given two n×n matrices D and W: find PεSₙ that minimizes tr(PDP^{T}W). Note that W=XX^{T} corresponds to the STS problem.

The general QAP is considered an extremely difficult optimization problem. It is known to be NP-Hard even to approximate, and in practice, usually untractable for n more than 30 (See [5] for a comprehensive survey of the problem). The particular choices of F that were made for the present Examples are shown to be also NP-hard, and therefore two analogous heuristic search algorithms were proposed, aimed at finding a global minimum.

These two algorithms are now explained in more detail below.

Side-to-side.

The algorithm of STS is summarized as follows:
Input: D_{n×n} and a strictly increasing vector X
1. Compute S=DX.
2. Sort S in descending order to get S′ P(S), where P is the sorting permutation.
3. If P(S)!=S, set D=P D P^{T} and go to 1.
4. Output D.

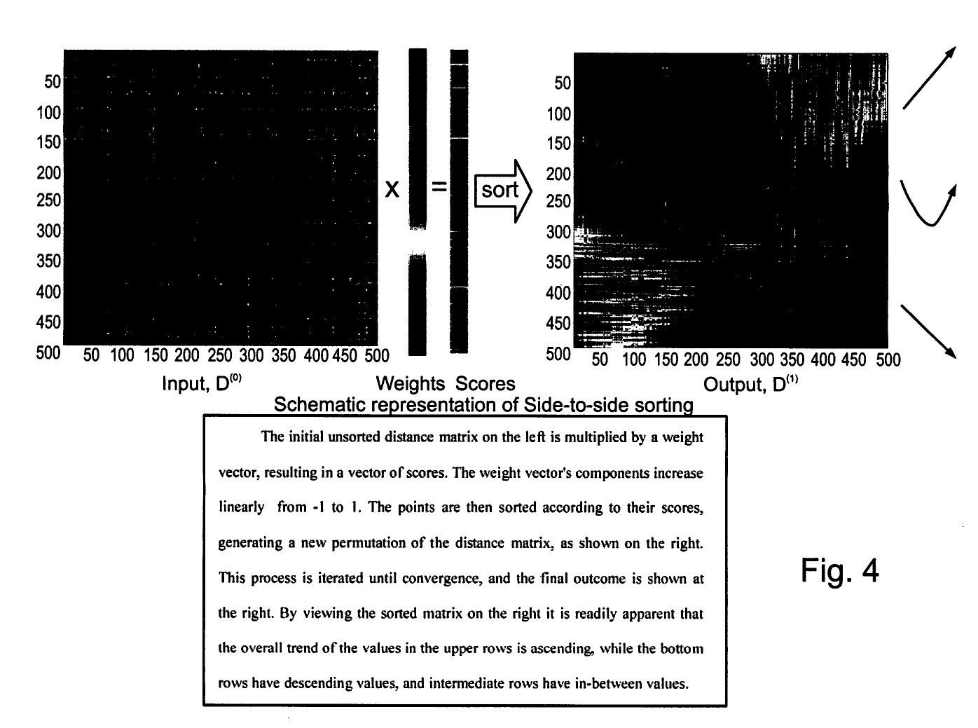

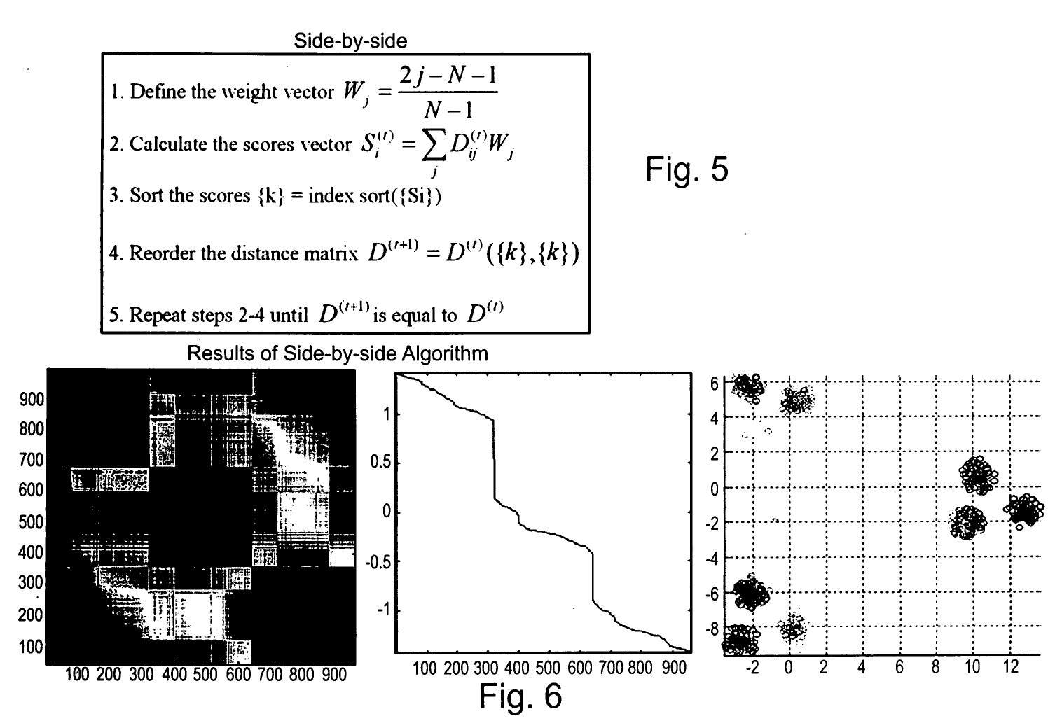

Given a distance matrix D, multiply it by a weight-vector W; the resulting vector S is termed “scores” (see FIG. 4). Since dot product is a measure of distance between two vectors, the scores reflect the degree of similarity between every row in the input matrix and the weight-vector. Our particular choice of weights, Wⱼ=(2j−N−1)/(N−1), is a linearly ascending vector, from −1 to 1. Hence, the score of a particular line reflects the slope of the linear regression of its values.

In the second step the score vector is sorted in descending order, and this is taken as the new ordering of the points. Since the distance matrix is symmetrical, reordering the points dictates rearranging both rows and columns. The change in the order of the columns alters the order of the values in all rows. This means that if we repeat the process of scoring, the new score of a row will, in general, differ from the old one. This is resolved by iterating the process of scoring and sorting.

We call each time we pass steps 1-3 a STS iteration, whose complexity is O(n²). Each STS iteration can be viewed as a mapping from the permutation group Sₙ to itself, G_{D}: Sₙ->Sₙ. Thus P is a possible output of STS if and only if it is a fixed point of G_{D}. Note that the resulting fixed point may not be a global minimum of F, as for different initial permutations the algorithm may terminate at different fixed points, with different values of F. A known strategy to cope with this problem is to start the algorithm from many randomly generated initial permutations, and choose the best fixed point obtained. Moreover, it is also possible to have multiple global minima. For example, define for every permutation P its ‘reverse’ P̅ by P̅(i)=P(n+1−i); (i=1, . . . , n). If X is anti-symmetric we get F(P)=F( P̅), leading to at least two global minima. Some data sets may even contain further degeneracies due to inherent symmetries.

As a concrete example, when the algorithm is applied to data comprised of three well separated “superclusters”, each of which consists of three dense spherical sub clusters close to each other (see FIG. 6), the sorted distance matrix displays clearly the structure of the data. FIG. 6 shows the end result of applying Side-to-side to data composed of 960 points in 9 spherical clusters in 3D. The left image presents the final ordering of the distance matrix. The middle graph presents the final score vector. The right most image displays the data points in the first and second PCA.

The three super-clusters are visible as dark blue squares along the main diagonal and their actual separation in the true multi-dimensional space is captured by the colors of the regions connecting these dark squares. At a higher resolution, the three sub clusters are also apparent. Furthermore, their relative positions can be inferred by the shading of the relevant rectangles in the distance matrix. The sizeable separation of the super-clusters is reflected in the final score vector in the form of large jumps that correspond to the boundaries between super-clusters, and smaller jumps corresponding to individual clusters.

Neighborhood.

The algorithm of Neighborhood is summarized as follows:

input: D_{n×n} and W_{n×n}

1. Compute M=D W

2. Set P=arg min_{QεS}_{ₙ}tr(QM).

3. If tr (P M)!=tr(M), set D=P D PT and go to 1.

4. Output D.

Each passage of steps 1-3 is a Neighborhood iteration. Step 2 is accomplished by solving the Linear Assignment Problem. This solution reflects the best current guess for an improved location for all the data points. At every iteration, points are sent to their new location, based on the current ordering of the points. However, since all the points are permuted simultaneously, there is no guarantee that the previous assignment is optimal for the new ordering. Hence the need to re-iterate. Since the Linear Assignment Problem is known to be solvable in time O(n³) [6], the complexity of each iteration is O(n³).

This algorithm of SPIN relocates points to the local neighborhood that best fits them. In this context a neighborhood is defined by a positive weight matrix Wᵢⱼ with a finite range σ. For example we use Gaussian weights,

$${W}_{ij} = {ⅇ}^{\frac{{( i - j )}^{2}}{2 {σ}^{2}}} .$$

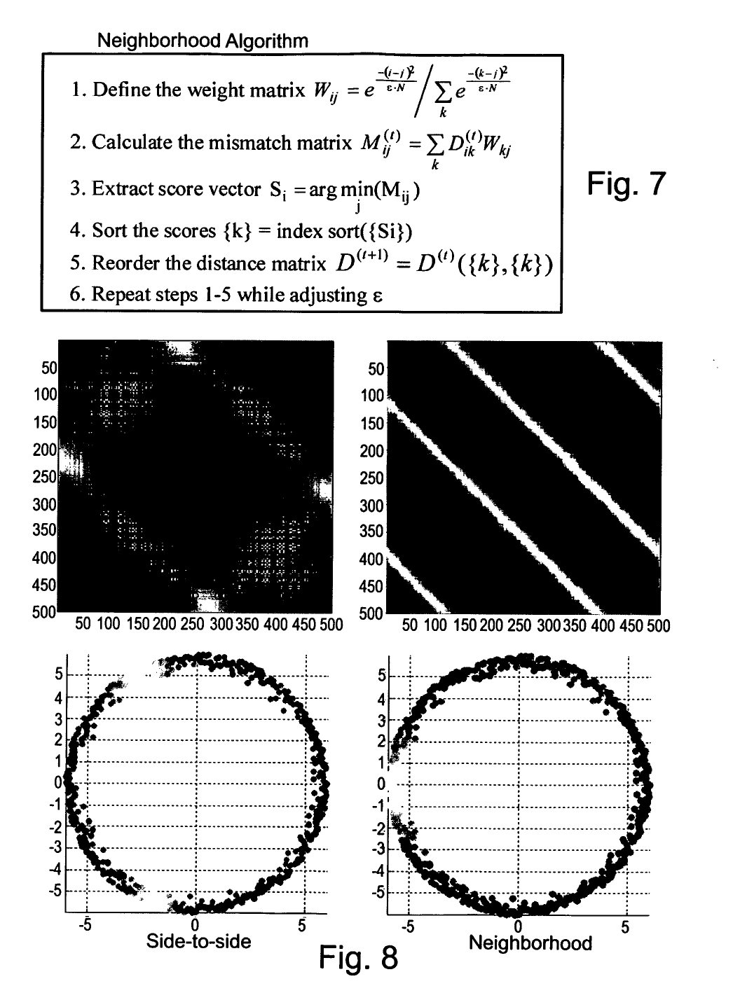

The size of the neighborhood affects the scale at which objects are distinguished. By taking the product of the distance matrix with W we perform Gaussian smoothing of width σ on each of its rows; we call the result the mismatch matrix Mᵢⱼ. The index of the minimum in the smoothed row i, termed the score Sᵢ, reflects the best current guess for an improved location for that particular point. The vector of scores is calculated for all points i simultaneously, as explained in FIG. 7. The relocation of points is achieved by sorting the score vector, same as in the first algorithm. However, more than one row can have the same index as its minimum, so tie breaks have to be accounted for. One way to do this is by using the linear assignment problem, while another is to bias the index of the minima by their actual values.

Since all the points are relocated at the same time, the points in the target regions also change, so the process of scoring and sorting is repeated iteratively, until convergence is reached or the number of iterations exceeds a preset bound.

The current implementation is as an interactive GUI so that the user chooses how to adjust σ manually. For a given data set there exists a range of relevant σ values where the resulting sorted distance matrix reflects the structure of the data at that resolution. In general, relatively large σ values correspond to working at low resolution, which allows the user to study the over all layout of the data, and observe the main separations. Smaller σ values can give a better local organization (near the main diagonal) at the expense of possibly fragmenting larger clusters. At the extreme end of small σ this is simply a nearest neighbor algorithm. One heuristic scheme that usually works well is starting with a very large neighborhood, iterating several times, then lowering ε (e.g. by a factor of 2) and so forth.

Although both algorithms find a one dimensional ordering of the data set, the characteristics of the final permutations are different in the following sense: Side-to-side (denoted STS) enforces a particular pattern on the image of the distance matrix, one that places red points (which denote large distances) in the top-right (and bottom-left) corners. Thus points that are placed far apart in the linear ordering are also distant in the full high-dimensional space. Neighborhood, on the other hand, tries to make sure that neighboring points in the linear ordering are close to each other in the high dimensional space. This subtle distinction, in emphasis may lead to substantial difference in the results, as illustrated in FIG. 8 for points in a ring formation.

The left image is the result of STS, which tries to position red points in the top-right (and bottom-left) corners. The image on the right is the result of neighborhood sorting, which aims to avoid placing red points near the main diagonal. As a result, the optimal Neighborhood permutation orders the points around the circumference of the ring. Due to the cyclic symmetry of the ring, the end points in this ordering are very close to one another in the original space. This does not conform to the pattern that STS imposes.

For both algorithms, the score is shown to be improved on every iteration, thus convergence, to a fixed point is guaranteed after a finite time (see below for outline of proofs of complexity and convergence).

Proofs of Complexity

Claim: The Side-to-Side problem is NP-Hard

Proof: Let G=<V,E> be some graph on n vertices. Define D as follows:

if (Vi,Vj)εE then Dij=1, else Dij=2.

Set Dii=0.

Let kε[1,n] be some integer, and set Xi=1(i>=n−k+1). It can be easily shown that G has a clique of size k if and only if min_{PεS}_{ₙ}X^{T}PDP_{T}X=(k−1)k. Thus, STS reduces to the k-clique problem, which is known to be NP-complete (Garey and Johnson [14]).

Claim: The Neighborhood problem is NP-Hard

$$Proof \text{:} Setting Wij = 1 \{ \vert i - j \vert = 1 \} gives tr ( PDPTW ) = {\sum }_{i = 1}^{n - 1} {D}_{P ( i + 1 ) , P ( i )} .$$

We get a reduction from the Traveling Salesman Problem, known to be NP-Hard, even in the Euclidian case (Papadimitriou [15]).
Proofs of Convergence

We first give the STS algorithm in a slightly revised manner, where P operates on X instead of D:

$$Input \text{:} D and X . \\ \begin{matrix}1. & Set {X}^{0} = {X}_{i} t = 0 , Q = {I}_{n \times n} , define {P}^{- 1} = {I}_{n \times n} . \\ 2. & Calculate {S}^{t} = D {X}^{k} . \\ 3. & Find {P}^{t} which sorts {S}^{t} in a descending order . \\ 4. & If {P}^{t} {S}^{t} \neq {P}^{t - 1} {S}^{t} , set {X}^{t + 1} = {P}^{T} {X}^{0} , Q = Q {P}^{t} , set t = t + 1 and go to 2. \\ 5. & Output Q D {Q}^{T} .\end{matrix} \qquad □$$

It can be easily seen that this algorithm presentation is equivalent. We now prove the following lemma:

Lemma

1. X^{^{T}}DX≦(QX⁰)^{T}DX, ∀QεSn, [symbol] ≧0

2. X≠X [symbol] XDX<X^{^{T}}DX

Proof

1. Note that:
X^{^{T}}DX=(P^{^{T}}X⁰)^{T}DX=X⁰^{^{T}}PDX≡X⁰^{^{T}}U(QX⁰)^{T}DX=X⁰^{^{T}}Q^{T}DX=X⁰^{^{T}}Q^{T}(P)⁻PDX≡x^{Q}^{^{T}}U (1)
And X is some permutation of X⁰, for any QεS_{. But, U} is a non-increasing vector, while X⁰ is a strictly increasing vector. Thus, according to a theorem by Hardy, LittleWood and Polya (Hardy et al. [10]) X⁰U≦Q(X⁰)U, ∀QεS_{, so X}⁰U ≦X^{Q}U, as desired.

2. From the first place it follows that X^{^{T}}DX≦X^{Q}U. Assume negatively that equality holds. Then, we get: X⁰^{^{T}}PDX=X^{^{T}}DX =X^{^{T}}DX=X⁰^{^{T}}PDX.
But X⁰ is increasing, PDX is decreasing and PDX is a permutation of it. Therefore PDX=P^{DX}, and thus PDX is non-increasing, and since we have started from it, we get P=P and X=X, which is a contradiction.

We can now prove the following theorem:

Theorem:
Take n distinct points z, . . . zⁿ εR, for some d εN, and a real p ε(1, 2|, such that:
   D=∥z−z∥p, 1≦i,j≦n
   Suppose that X is strictly monotonically increasing (X≦X [symbol] i≦j). Then algorithm Side-to-Side converges to a point after a finite number of iterations.

Proof:

According to Thm. 2.11 in Baxter |4|, D is Almost Negative Definite. That is ,we have for any vector V such that Σ [symbol] V [symbol] =0, v^{T}DV≦0. Since for every [symbol] X is a permutation of X it follows that
(X−X)^{T}D(X−X)≦D (2)

Since D is symmetric it follows that

$$\frac{{X}^{t + {1}^{T}} D {X}^{t + 1} + {X}^{{t}^{T}} D {X}^{t}}{2} \leq {X}^{t + {1}^{T}} D {X}^{t} \qquad ( 3 )$$

Subtracting H^{^{T}}DX from both sides of 3 one obtains

$$\frac{{X}^{t + {1}^{T}} D {X}^{t + 1} - {X}^{{t}^{T}} D {X}^{t}}{2} \leq {X}^{t + {1}^{T}} D {X}^{t} - {X}^{{t}^{T}} D {X}^{t} . \qquad ( 4 )$$

But the algorithm never stays at the same point for more than one iteration (step 4), namely X≠Xand therefore, according to the previous lemma:
X^{^{T}}DX−X^{^{T}}DX≦0
To conclude, the energy function [symbol] ( [symbol] )=X^{^{T}}DX is strictly decreasing function of t. Therefore the algorithm terminates after a finite number of steps.

The proof from above proves that for Lₚ norms with pε(1,2], SPIN converges to a local minima of the dynamical energy [symbol] (X,X)=X^{^{T}}DX. Converges to a global minima of [symbol] ₓ is not guaranteed. For other norms, SPIN might converge to a cycle, however the cycle can be viewed as a local minima, since it still minimizes [symbol] (XX) (All the cycle has the same [symbol] .)

Convergence of Neighborhood:

To prove convergence, we revise the Neighborhood algorithm as follows:

$$\begin{matrix}\text{Input:} D and W \\ 1. Set {W}^{ 0} = W , {P}^{- 1} = {I}_{ n \times n} , t = 0 \\ 2. Compute {M}^{t} = D {W}^{t} . \\ 3. Set \\ {P}^{t} = {argmin}_{Q ∈ {S}_{n}} tr ( Q M ) \\ 4. If {P}^{ t} \neq {P}^{ t - 1} , set {W}^{t + 1} = {P}^{{t}^{T}} W and go back to step 2. \\ 5. Output {P}^{ t} D {P}^{ {t}^{ T}} \\ \text{Claim:} & \\ tr ( {P}^{ t + 1} D {P}^{ {t}^{ T}} W ) \leq tr ( {P}^{ T} D {P}^{ t - {1}^{ T}} W ) \\ \text{Proof:} & ( 5 ) \\ tr ( {P}^{t + 1} D {P}^{{t}^{T}} W ) = tr ( {P}^{t + 1} D {W}^{t + 1} ) \leq tr ( Q D {W}^{t + 1} ) ∀ Q ∈ {S}_{u} \\ Using the symmetry of W and the property tr ( A B ) = tr ( B A ) we get \text{:} \\ tr ( Q D {W}^{t + 1} ) = tr ( Q D {P}^{{t}^{T}} W ) = tr ( {( Q D {P}^{{t}^{T}} W )}^{T} ) = & ( 6 ) \\ tr ( W {P}^{t} D {W}^{T} ) = tr ( {P}^{t} D {Q}^{T} W ) & ( 7 )\end{matrix}$$

Taking Q=^{p} in 7 gives the desired result.

Using the above claim, a proof of the algorithm termination can be obtained, similarly to STS. We skip the details here.

Proof of Neighborhood Convergence

First we revise the algorithm to an equivalent form:

Neighborhood (Rev.)

Input: Dn×n and Wn×n

1. Set W0=W, P−1=In×n, t=0.

2. Compute Mt=DWt.

3. Set P^{t}=arg min_{QεS}_{ₙ}tr(QM^{t}).

4. If tr(PtMt) 6!=tr(Pt−1Mt−1), set Wt+1=PtTW, t=t+1 and go to 2.

5. Output PtDPtT.

Claim: tt(Pt+1DPtTW)<=tr(PtDPt−1TW)

Proof: tr(Pt+1DPtTW)=tr(Pt+1DWt+1)·tr(QDWt+1)^{∀QεS}^{ₙ}

Using the of W and the property tr(AB)=tr(BA) we get:

tr(QDWt+1)=tr(QDPtTW)=tr((QDPtTW)T) =tr(WPtQT)=tr(PtDQTW)

Taking Q=Pt−1 gives the desired result.

According to step 4, the algorithm terminates unless a strict inequality holds in the above claim. This prevents cycles of constant energy. Since the permutation space is finite, termination in a fixed point after a finite number of steps is guaranteed.

The current implementation of SPIN is as an interactive GUI, which enables the user to use either STS or Neighborhood. In general, STS is simpler, faster, and convergence seems to be quick for all the examples we have tried so far. It has no parameters, so the final ordering depends only on the initial permutation. Neighborhood, on the other hand, seems to capture features of the data which are missed by STS. For STS, one exemplary choice of weights is

$${X}_{j} = \frac{2 j - n - 1}{n - 1} ,$$

which is an anti-symmetric linearly ascending vector, from −1 to 1. For this particular choice, (DX)ⱼ is simply the slope of the linear regression of the values in the j^{th} row of D.

One exemplary choice for the weight matrix of Neighborhood is taken to be Gaussian

$${W}_{ij} = {ⅇ}^{\frac{{( i - j )}^{2}}{2 {σ}^{2}}}$$

which is then normalized to be doubly stochastic (i.e. sum of each row and column is equal to one). For a given data set, there exists a range of relevant length scales, where large scales reflect the over all layout of the data while smaller values give a better local organization at the expense of possibly fragmenting larger structures. This is captured in SPIN by controlling the value of σ. One heuristic scheme that usually works well is starting with a very large sigma, iterating several times, then lowering σ (e.g. by a factor of 2) and so forth.
Section II-Illustrative Examples and Applications

This Section describes some illustrative, non-limiting examples and applications for the method according to the present invention, demonstrated according to a preferred embodiment of the method, termed herein SPIN. A sorting algorithm, such as the method presented herein, is particularly useful in cases where the effect of some continuous parameter needs to be studied.

A specific example of the type of data where this form of analysis may be pertinent is biological experiments, such as genome-wide experiments for example. For example, the expression profile of synchronized cells is governed by the time in cell-cycle progression in which a particular sample was harvested, as demonstrated in Example 3. In Example 4, initial findings from the analysis of cancer data are presented. Example 5 demonstrates the use of the present invention for machine or robot vision.

In these cases, SPIN's ability to ferret out elongated structures, even when the elongation refers to a complicated contour embedded in a high dimensional space, is extremely valuable.

### EXAMPLE 3

### Yeast Cell-Cycle

A sorting algorithm, such as the one we present, is particularly useful in cases where the effect of some continuous parameter needs to be studied. A specific example of the type of data where this form of analysis may be pertinent is genome-wide experiments. For example, the expression profile of synchronized cells is governed by the time in cell-cycle progression in which a particular sample was harvested. In these cases, SPIN's ability to ferret out elongated structures, even when the elongation refers to a complicated contour embedded in a high dimensional space, is extremely valuable.

We chose to present here analysis of the yeast Elutriation-Synchronized cell-cycle expression data (taken from [1]). Spellman et al. employed a supervised ‘phasing’ method to assign genes to five known classes, namely G1, S, S/G2, G2/M and M/G1, utilizing the expression profiles of genes that were previously known to participate in specific phases of the cell cycle. They then proceeded to perform unsupervised analysis, specifically hierarchical clustering, and found that most genes belonging to the same class were clustered together. In another work, [2] further improved the organization of the tree by employing a leaf ordering algorithm, and recovered the order of the phases in the cycle.

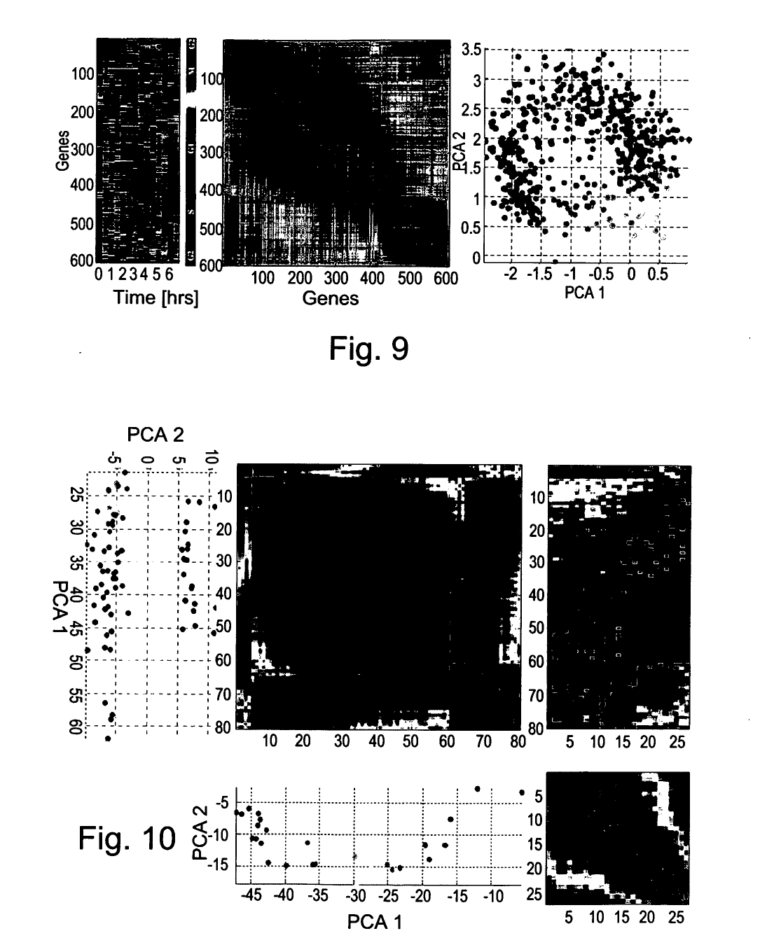

Here we suggest the sorting approach as a different exploratory analysis methodology. Instead of partitioning the genes into distinct clusters we generate a distance matrix and order it by SPIN. As explained in Section I above, the nature of a cyclic object can be deduced from the colored pattern in the sorted distance matrix (FIG. 9b): a blue elongated patch around the main diagonal, and two additional blue corners (upper right and lower left). Indeed, assigning such a cyclic nature to genes associated with cell-cycle is in accordance with known biological dynamics and functions [3]. Inspecting the sorted image at a higher resolution reveals the heterogeneous nature of the ring, indicating a further separation into the individual stages of the cycle. Therefore, information about the distinctive cell-cycle phases is not lost; while an understanding of the over all cyclic nature is gained.

The technical details of our analysis for this data set are as follows: The raw expression data was downloaded from a server at Stanford (http://cellcycle-www.stanford.edu), and included a total of 5,981 genes measured across 14 samples (which denote several consecutive stages along the cell-cycle). The only pre-processing step was a variance filter: the standard deviation was calculated for each of the 5,981 genes, and only the 600 genes with the highest values were chosen for analysis in SPIN. The gene distance matrix of size 600×600 was calculated using simply Euclidian distance metric, and sorted in SPIN, as shown in FIG. 9b. In this case the Neighborhood sorting algorithm was utilized, with σ²=5*600 for 10 iterations. This example highlights the ease of ordering gene expression data in SPIN, and the informative and intuitive nature of the color-enhanced output provided by our tool. Previous studies have recognized the inherent cyclic nature of this data set [3], but required several stages of data manipulation and normalization, followed by a manual ordering along the PCA projection to convey the results that are easily captured in SPIN.

FIGS. 9-9C show the following with regard to the analysis of yeast data according to the present invention: (a) The sorted expression matrix. The genes were sorted by SPIN and the matrix is ordered according to that permutation. The samples are ordered according to time. (b) The sorted distance matrix for the 600 genes, calculated in sample-space. The cyclic nature is quite visible. Upon closer inspection one can see that the ring separates into 3 main elongated clusters. (c) The projection of genes on the first and second PCA. Annotation of cell-cycle stages is based on the ordering presented in, [3], to which SPIN's ordering has 85% correlation.

In the general context of expression data SPIN provides a two-way sorting platform, i.e. it is possible to order both samples and genes. In the specific case of the yeast cell-cycle data the samples are already organized and labeled accord to the stage in cell-cycle progression from which they were harvested. Therefore, we proceeded to sort only the genes, and left the samples ordered according to their labels. However, we did examine the organization of the Euclidian distance matrix for the samples (of size 14×14). One interesting observation is that the samples also order in a cyclic conformation of a ring. This observation is in accordance with the biology of the experiment, since each sample represents the expression profile of a yeast cell during consecutive stages of the cell-cycle.

### REFERENCES FOR YEAST SECTION

1. Spellman P T, S. G., Zhang M Q, Iyer V R, Anders K, Eisen M B, Brown P O, Botstein D, Futcher B., Comprehensive identification of cell cycle-regulated genes of the yeast Saccharomyces cerevisiae by microarray hybridization. Mol Biol Cell, 1998. 9(12): p. 3273-3297.

2. Bar-Joseph Z. G. D., Jaakkola T S, Fast optimal leaf ordering for hierarchical clustering. Bioinformatics, 2001. 17: p. S22-9.

3. O. Alter, P.OB.a.D.B., Singular Value Decomposition for Genome-Wide Expression Data Processing and Modeling. PNAS, 2000. 97(18): p. 10101-10106.

### EXAMPLE 4

### Cancer Research—Contamination

The present invention used SPIN in the analysis of expression data originating from large-scale cancer experiments. A known problem in microarray experiments is that a given sample is usually contaminated by a mixture of cell types, so that the expression signal from the desired target may be partially masked [2].

The method of the present invention was used to analyze genomic data obtained from human leukemia patients. Expression data was used from Table 3 in ([17]), who identified 80 genes that separate Pro B-cell from pre B- and T-cell ALLs. The analysis presented in (10), may link those genes to hematopoiesis, which is the process of generation and differentiation of blood cells. During hematopoiesis stem cells divide and undergo differentiation to various stages, gradually losing their multipotencity (11).

In the present analysis both the samples and genes were reordered using SPIN. By looking at the reordered distance matrices in FIG. 10 one can clearly see that the samples form an elongated cluster, which may be indicative of a gradual differentiation process. As shown in FIG. 10 (sorted expression) the figure parts are as follows: Clockwise from top left: PCA of genes in sample-space, ordered distance matrix of genes, ordered expression matrix in logarithmic scale, distance matrix of the samples, PCA of the samples in gene-space.

When the expression data is ordered in both directions it becomes apparent that most (about 60) genes are gradually turning off, and a minority of 20 genes, specific of the final target of the process, are turned on as differentiation proceeds. The gradual decrease in transcription viewed here is in accordance with the hypothesis that stem cells possess an open chromatin structure, which is progressively quenched during differentiation (12).

### EXAMPLE5

### Machine Vision

As previously described, the present invention is useful for any type of analysis problem involving the analysis of large sets of multidimensional data, including those characterized by having continuous variables. One example of such data is pattern recognition for machine or robot vision.

As an exemplary data set, the multi-feature digit dataset was examined. This dataset consists of features of handwritten numerals (‘0’-‘9’) extracted from a collection of Dutch utility maps (13-14). Two hundred patterns per class (for a total of 2,000 patterns) have been digitized in binary images, which have subsequently been averaged in windows of 2×3, resulting in 240 averaged pixels per image. Each pattern is thus represented as a vector of 240 elements, with values ranging from 0 to 1. The 2000×2000 Euclidean distance matrix between the patterns was calculated; optionally other distance matrices could also be used. One advantage to selecting a simpler distance measure such as Euclidean distance is that the characteristics of the measure itself do not bias the results in a particular direction. The distance matrix was then sorted by Neighborhood, using a series of decreasing values of σ (σ²=1,000,000, 500,000, 100,000, etc.) until convergence.

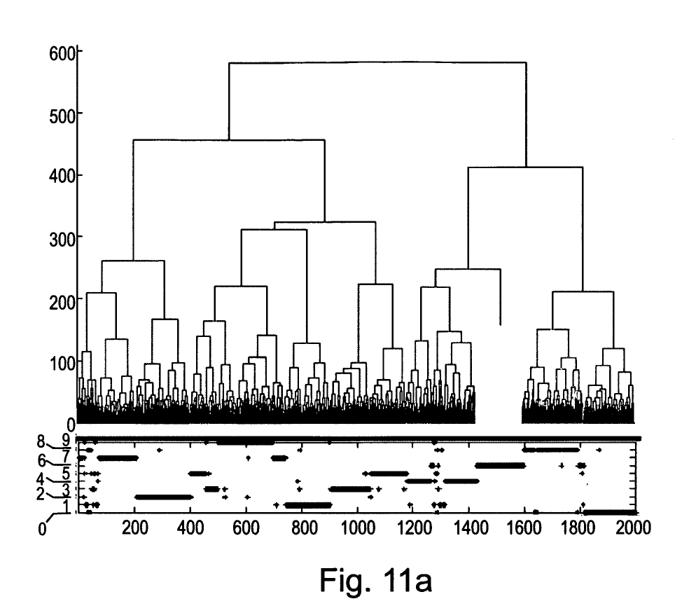

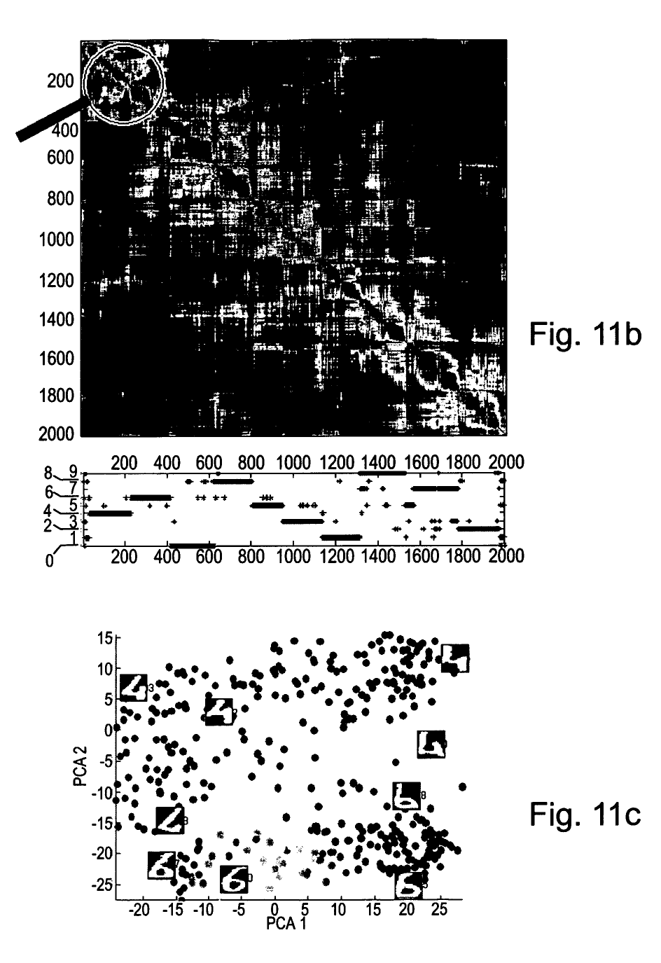

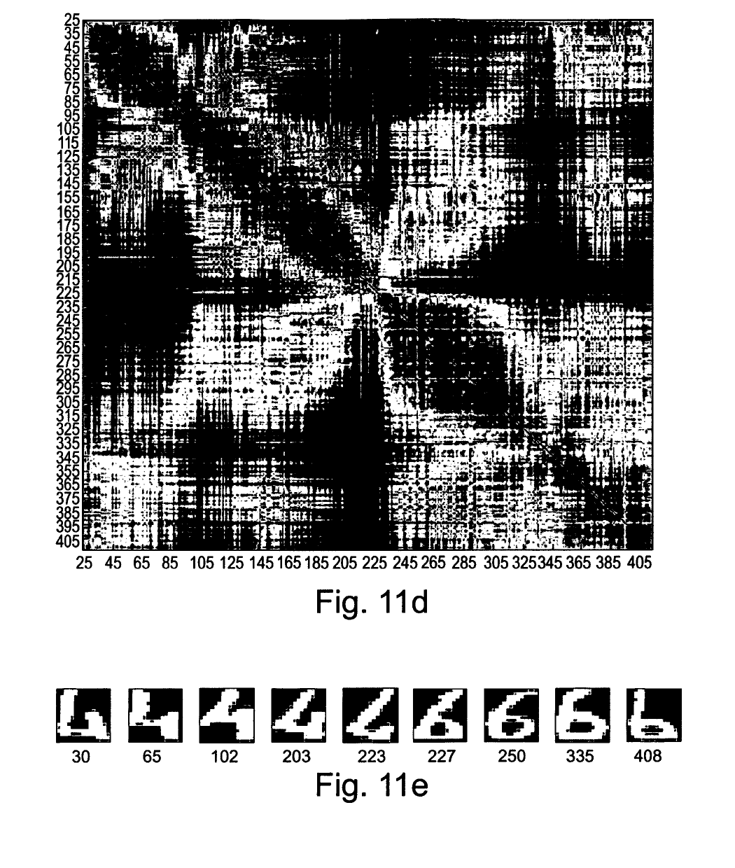

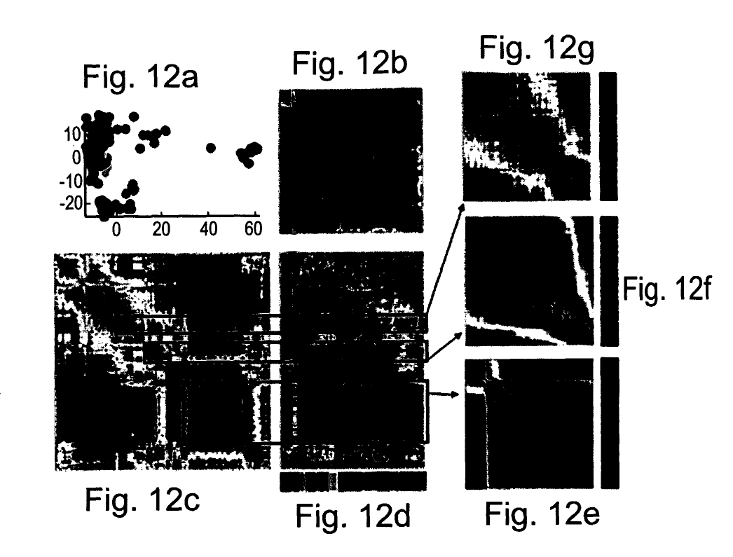

FIG. 11 shows the results of analyzing the patterns required to recognition the numerals as numbers: (a) Dendrogram generated by the Ward linkage algorithm, hand colored to best represent the correct classification of the digits, identified by the blue dots on the bottom panel. This was done as a control in order to show that in the context of classifying, the quality of our method is as at least as good as common clustering methods. However, as the results show, the method according the present invention is better than common clustering methods, which are less successful for this type of problem. (b) The SPIN reordered distance matrix. As can be seen in the bottom panel the classification according to digit type is quite good. Moreover, from this distance matrix, several other features of the data become apparent. For example the digits as a whole seem to form an elongated structure with the digits ordered, as follows: 4, 6, 0, 8, 5, 3, 1, 9, 7, 2. Some digits, such as 4 and 6 are very similar and seem to morph from one to the other, but are very different from other digits such as 7. (c) Looking in more detail at the sub-matrix of fours and sixes: First two PCA colored according to the order suggested by SPIN going from dark blue to dark red. A few sample digits are displayed in the appropriate locations. Note the growth of the “leg” of the “4” then the swing of the left-upward stroke from vertical to 45° then shrinkage of the leg, transformation into “6” and finally return of the upward stroke to vertical. (d) The distance sub-matrix displaying an ‘X’ pattern. (e) Some sample digits arranged in the order of SPIN.

As can be seen in FIG. 11, SPIN groups the images in good accordance with the known labels. A comparably accurate partition is also provided by hierarchical clustering, and presented in the form of a dendrogram. From the sorted distance matrix one can deduce further information: The overall layout of the data has an elongated shape, implying that the images lie along a complex trajectory, with one numeral morphing into the next. In fact if the sorted images are displayed consecutively, the resulting movie is relatively smooth, and the shapes appear to be gradually evolving over time. Even the transition between different classes is mostly gradual, as exemplified in the zoom-in where the left vertical stroke of the “4” tilts to the right, then the “4” morphs into “6” and the stroke tilts back towards the vertical. The relationship between the “4” and “6” clusters is of the type we termed “anti-parallel rods”, as can be seen in FIG. 6, where the 2D projection of these points is presented. The hallmark of such a structure is an X shape on the distance matrix.

A zoom-in operation in this context refers to extracting a sub-matrix from the input data, and regarding it as a “new” data-set. The distances are recalculated using only the remaining information in this sub-matrix. This is somewhat reminiscent of local PCA. SPIN thus allows the evaluation of the effects of sub-sets of the features on the data points. At the same time it also allows the evaluation of sub-sets of the data on the importance of the features. As an example, some of the pixels in the images of digits are always black (0) and thus do not contribute at all to the distances between patterns. Other pixels only change within a sub-set of the digits, and are thus important for discriminating between them, but not between others.

### EXAMPLE 6

### Colon Cancer

The method of the present invention was also used to analyze colon cancer. The biological question addressed here is that of recognizing alterations in gene expression that may be linked with the progression of cancer. SPIN is especially appropriate for this analysis, since cancer evolution is an inherently continuous process, which arises from a gradual accumulation of genetic alterations that promote selection of cells with increasingly aggressive behavior. Such continuity may be completely overlooked by traditional methods that emphasize clear separations.

Colon cancer is a good model system since samples are readily available across several, well-defined, stages of the disease, enabling a study of the onset of the neoplastic transformation. Expression profiles were determined for seven types of samples using the Affymetrix U133A GeneChip [D. Tsafrir, W. Liu, Y. Yamaguchi, I. Tsafrir, Y. Wen, W. Gerald, R. Stengel, F. Barany, P. Paty, F. Domany, and D. Notterman. A novel mathematical approach to analyzing gene expression data results from an international colon cancer consortium. In proc. of AACR-2004, 2004]: 47 primary carcinomas; 24 adenomas; 22 normal colon epithelium; 16 liver metastasis; 19 lung metastasis; 11 normal liver; and 5 normal lung. Standard pre-processing of the data included thresholding to T=10 and log transformation. A variance filter was utilized to concentrate on the most relevant genes. The process was started with the 500 highest varying transcripts, then doubled the number; since there was a significant change in the results, the number of transcripts was doubled again, to 2000. This did not alter the main conclusions to a noticeable degree, so many of the results were obtained with the top 1000 samples.

The results are shown in FIG. 12 as follows: colon cancer data; expression levels of the 1000 highest variance transcripts over all 144 samples. (a) Projection of the samples onto the first (x-axis) and second (y-axis) principal components, calculated in gene-space. The clinical identity of samples is indicated by a color: primary carcinomas (blue); adenomas (green); normal colon (red); liver metastasis (magenta); lung metastasis (orange); normal liver (black); and normal lung (cyan). This coloring scheme for tissues is kept in all sub-figures. The first PCA reflects 34 percent of variance, and is dominated by the differences between normal liver and all other samples. (b) SPIN-permuted distance matrix for the samples. Colors depict dissimilarity levels between samples, with red (blue) indicating large (small) distances. (c) Genes SPIN-permuted distance matrix. The genes display several distinct expression profiles. (d) Two-way sorted expression matrix. Here colors depict relative expression intensities, where red (blue) denotes relatively high (low) expression. The colored bar below the matrix provides the tissues' clinical identity. Some of the dominant gene-clusters and their expression levels are highlighted by dark rectangulars. Each gene-cluster is used to construct the distance matrix of a particular subset of the samples (e) The distance matrix of normal liver, liver metastasis and carcinoma samples, as calculated in the subspace of the liver-specific gene cluster. The normal liver and carcinoma samples form two distinctly separated, tight spherical clusters, while the metastasis form a connecting elongated cloud, with some of the samples displaying higher proximity (i.e. similarity) to the normal liver samples. The 6 metastasis samples that were placed farthest from the liver samples presumably contain lowest amounts of normal liver tissue, and are therefore referred to as clean metastasis.(f) Muscle and connective tissue associated genes. Expression profiles related cell-mixtures can be distinguished in SPIN by the fact that affected samples tend to order into an elongated shape, due to the relatively high variations in samples' composition. Here the normal colon samples' ordering is indicative of levels of muscle and connective tissue contamination, lowest in the polyp samples. (g) Genes related with a gradual loss of differentiation. Note the placement of the polyp samples between normal and cancer tissue. In (e)-(g) the tissues' clinical identity is given by the colored bar to the right of each distance matrix.

In the context of such complex data, the search for genes and pathways that are causally involved in cancer is complicated by the need to distinguish their signal from a large background of innocent bystander genes, whose expression levels appear altered due to secondary causes. An initial objective is to generate an overall impression of the data's structure, identifying major partitions and relationships. By filtering the highest variance genes and ordering the resulting expression matrix in SPIN (see FIG. 12d) one can get a global view of the data. Two separate ordering operations were performed: one on the genes' distance matrix (rows; FIG. 12c) and another on the samples' distance matrix (columns; FIG. 12b). Thus, the two-way organized expression matrix allows one to study concurrently the structure of both samples and genes.

In consecutive analysis stages, detailed in the following paragraphs, the process focused individually on sets of correlated genes that were identified in this initial step. SPIN is used to re-order the samples in the context of each gene-set separately, and the resulting permutation is shown to be informative of the underlying biology (see FIG. 12e-g). This process of iteratively identifying and focusing on relevant subsets of the initial data matrix is reminiscent of the previously proposed Coupled Two-Way Clustering algorithm [G. Getz, F. Levine, and F. Domany. Coupled two-way clustering analysis of gene microarray data Proc. Natl. Acad. Sci., USA, 97(22):12079-12084, 2000].

This Example also includes a consideration of the effect of overrepresentation of, or contamination by, particular types of tissues. Previous expression-data studies recognized the challenge posed by the heterogeneous composition of sampled tissues [Alon et al., 1999], which was not answered in the context of traditional analysis methods [Ghosh, 2004]. In the current data the clearest separation in the samples is according to their organ of origin—either colon, liver or lung—with the liver samples forming the most distinct group (see FIG. 12b). Even though the tissue samples were carefully dissected, the strongest expression signals are indeed related with the composition of the various samples.

The most prominent gene-cluster, highlighted by the bottom black rectangle (FIG. 12c-d), is characterized by highest expression levels in the liver samples. The annotation of genes belonging to this cluster is related to liver functions (including SERPINA3, CP, HP and APOCI), and therefore it is referred to as liver-specific. These liver-specific genes are totally irrelevant to the disease, and yet when performing a PCA projection of the samples (FIG. 12a) the first principal direction (explaining 34 percent of variance) is dominated by the difference between normal liver and all other samples. The highly relevant aspect of this phenomenon is that some of the liver metastasis samples' display elevated expression levels for the liver-specific genes, shifting their placement in the SPIN ordering towards the location of the normal liver samples. This hinders the ability of traditional statistical analysis methods to generate a list of genes associated with metastatic cancer; when searching for genes with high expression in liver metastasis versus carcinoma samples, liver-specific genes may be implicated. Indeed a supervised hypothesis test [Pan, 2002] generated a list of genes significantly over expressed in liver metastasis as compared to the primary tumor sample(387 transcripts out of the examined top 1000 passed the Wilcoxon ranksum test with FDR of q=0.05 [Benjamini and Hochberg, 1995]). The vast majority of these (97 percent) are associated with liver functions and are in fact members of our liver-specific cluster (FIG. 12e). The increased expression for these genes is probably a byproduct caused by contamination of the metastasis samples with normal liver tissue. Therefore, these genes could potentially serve as the basis for constructing a liver-metastasis classifier [Dudoit et al. , 2002]; However, analysis based on SPIN clarifies that they do not play a role in the progression of cancer, but rather as a tissue-of-origin indicator.

Other types of contamination were also seen, including muscle and connective tissue contamination. As demonstrated above, the problem of tissue heterogeneity may be a major complication, and one that was mostly unresolved by traditional analysis methods. In some data sets an assessment by the pathologist of the percentage of relevant tissues in each sample is available [Notterman et al., 2001, Alon et al., 1999], and this information can be utilized to construct an appropriate statistical test [Ghosh, 2004]. In the current data no such knowledge is available, which prevents the proper employment of supervised methods, and necessitates the use of an unsupervised approach.

For example, consider a group of genes that appear significantly under-expressed in the neoplastic samples as compared with normal tissue (434 transcripts out of the examined top 1000 passed the Wilcoxon ranksum test with FDR of q=0.05). It has already been observed in colon cancer studies that tumor samples are more biased towards epithelium tissue then their normal counterparts, causing apparent under-expression of genes functioning in muscle and connective tissues; [Alon et al., 1999]. In the SPIN-permuted data (FIG. 12c-d) the transcripts that show reduced expression in diseased tissue clearly separate into two different gene-profiles. One of this gene-clusters (FIG. 12f) exhibits extreme variation in expression in the context of the normal colon samples, which is visually manifested by a pattern of elongation in the relevant SPIN-sorted distance matrix (see FIG. 12f)). The annotation of these genes associates them with smooth muscle and connective tissue. Therefore, a likely cause for the disparity in expression among the normal samples are the differences in tissue composition. The reduced variability detected in the tumor samples (most tumors form a tighter, less elongated shape in FIG. 12f) is consistent with the observation made in earlier studies that those samples contain mostly epithelial tissue [Alon et al. 1999], and with the fact that in this experiment they were carefully dissected [Tsafrir et al., 2004]. The adenomas exhibit the lowest expression, perhaps associated with the fact that these benign precursors of cancer protrude into the lumen of the colon, making it easier to remove them surgically without inadvertently including some surrounding muscle or connective tissue. Therefore, using SPIN to study the profile of this gene-cluster clarified that even though the genes are significantly differentially expressed between normal and tumor they are not connected with the neoplastic transformation, but rather with tissue mixtures.

The method of the present invention was also shown to be able to detect gradual loss of differentiation, in addition to the artifacts described above. Employing supervised statistical tests to compare our normal colon samples with the tumors resulted in a mixed list, which included some genes that the SPIN analysis revealed to be related with tissue-mixtures. It is further possible using SPIN to distinguish the desired set of disease-progression associated. genes, and show that the reduction in their expression is correlated with the gradual onset of the cancer. Focusing on this subset of genes reveals that in this context the samples trace an elongated shape (FIG. 12g), with the normal colon epithelium placed to one side, followed by the adenomas that show a somewhat reduced expression, which is even lower in the carcinoma samples. This set includes genes that were observed to be preferentially expressed in human epithelial cells and down-regulated in cancer, such as carbonic anhydrases [Notterman et al., 2001], Guanylate cyclase activators [Birkenkamp-Demtroder et al., 2002] and EPLIN [Maul and Chang, 1999]. A plausible hypothesis is that these genes are associated with colon functions, and that the SPIN-permutation highlights a gradual loss of differentiation in the transformed tissue. Perhaps the percentage of cells that still keep their colon functions is steadily reduced with the progression of the disease. To conclude, supervised tests were employed to answer a specific question—e.g. differential expression in sick versus healthy tissue, while the analysis in SPIN revealed that some of the implicated genes answer a very different question, i.e. which samples contain the highest proportion of muscle and connective tissue.

The analysis of the colon cancer data demonstrates a situation where SPIN can be used to assign new labels to samples, and employ this knowledge to improve the application of supervised methods. Metastasis samples, for example, can be marked according to the degree of surrounding normal tissue inadvertently included in the sample's preparation. One way of gaining this information is in the context of the liver-specific cluster, where the samples' expression profiles can be viewed as the result of a gradual mixing process, starting with samples extracted from the colon, that contain no liver tissue, and continuing with the metastasis samples that vary in the amount of liver contamination. The degree of liver mixture in each sample is reflected by the SPIN ordering, as can be seen in FIG. 12e. The least contaminated metastasis samples can be distinguished by their placement next to the cluster of primary tumors, and labeled as clean. A clustering algorithm, such as average linkage, although clearly separating between normal liver and primary tumors, does not produce such meaningful ordering of the metastasis samples. Therefore, SPIN is especially useful in this situation since it can be used to perform a type of electronic-micro-dissection, allowing identification of the cleanest metastasis samples. A similar procedure can be performed for the lung metastasis samples by using the normal lung samples. It is than possible to proceed by focusing on the clean metastasis samples (from both liver and lung) to uncover genes relevant to the metastatic process. The resulting list included several known oncogenes (such as VEGF, OSE [Behrens et al., 2003],TGIF2 and UEE2C); in particular, some, are located on chromosomal arm 2 a region which has been previously shown to be amplified in metastatic colon cancer [Platzer et al., 2002]. In SPIN one can further observe that this group of genes exhibits a gradual elevation in expression which is coupled with the progression of the cancer—from normal tissue, through polyps, increasing in primary tumors and culminating in the clean metastasis samples.

In this work we presented several data sets where the ordered distance matrix generated by SPIN was extremely helpful in uncovering the structure of the data. One of the examples demonstrating SPIN's ability to reveal the layout of the data is the yeast cell-cycle. This data set was previously analyzed using hierarchical “clustering [7]. Despite being a very useful visualization tool, hierarchical dendrograms do not give a clear indication of the relative positions, symmetries, and shapes of the clusters. Another drawback of hierarchical clustering is the large number of possible leaf orderings of the clustering tree. The algorithm in [8] finds the optimal leaf-ordering with respect to the nearest-neighbors energy function, given a particular dendrogram. This energy function is a special case of Neighborhood with Wᵢⱼ=1|_{|i-j|=1}. Moreover, the requirement of an ordering satisfying a given dendrogram could be too restrictive, especially since different clustering algorithms may give different results for the same data set. SPIN, on the other hand, provides an, ordering of the objects using only the information available from the distance matrix, thus maintaining the ability to explore the entire permutation space, bypassing the need for a middle-man. Having said that, it may be beneficial to combine our sorting strategy with clustering. In such synergy the clustering algorithm would enhance the separation into clear clusters, while the sorter would help elucidate the shapes and relationships between the clusters.

Although SPIN can be viewed as a special case of dimensionality reduction (to one dimension), the emphasis is on ordering the points, rather than preserving their distances. Dimensionality reduction techniques, such as MDS, LLE [12] or Isomap [13], distort the distances. Therefore, the existence of a low-dimensional object can be discovered, however its structure is not readily inferred. Using SPIN, we have demonstrated that the re-ordered distance matrix highlights % structural features of the object embedded in the high-dimensional space. Furthermore, we have also shown how SPIN can enhance dimensionality reduction techniques, as exemplified above where the color coded ordering significantly clarifies the PCA image. To conclude, the sole input to SPIN is a distance matrix (not necessarily Euclidian) which makes it applicable to any problem involving arrangements of points in multi-dimensional space, where a metric can be defined.

### REFERENCES

[1] M. Eisen, P. Spellman, P. Brown, and D. Botstein. Cluster analysis and display of genome-wide expression patterns. Proc. Natl. Acad. Sci. USA, 95:14863-14868, 1998.
[2] U. Alon, N. Barkai, D. A. Notterman, K. Gish, S. Ybarra, D. Mack, and A. J. Levine. Broad patterns of gene expression revealed by clustering analysis of tumor and normal colon tissues probed by oligonucleotide arrays. Proc. Natl. Acad. Sci. USA, 96:6745-6750, 1999.
[3] D. Tsafiir, W. Liu, Y. Yamaguchi, I. Tsafrir, Y. Wen, W. Gerald, R. Stengel, F. Barany, P. Paty, E. Domany, and D. Nofferman. A novel mathematical approach to analyzing gene expression data: results from an international colon cancer consortium. In proc. of AACR 2004.
[4] T. Koopmans and M. Beckmann. Assignment problems and the location of economic activities. Econometrica, 25:53-76, 1957.
[5] R. E. Burkard, E. Cela, P. Pardalos, and S. L. Pitsoulis. The Quadratic Assignment Problem, volume 3, pages 241-339. Dordecht:Kluwer Academic Publishers, 1998.
[6] E. A. Dinic and M. A. Kronrod. An algorithm for the solution of the assignment problem. Soviet Math. Dokl., I0: 132-1326, 1969.
[7] P. T. Spellman, G. Sherlock, M Q. Zhang, V. R. Iyer, K. Anders, M. B. Eisen, P. O. Brown, D. Botstein, and B. Futcher. Comprehensive identification of cell cycle-regulated genes of the yeast saccharomyces cerevisiae by microarray hybridization. Molecular Biology of the Cell, 9:3273-3297, 1998.
[8] Z. Bar-Joseph, D. K. Gigord, and T. S. Jaakkola. Fast optimal leaf ordering for hierarchical clustering. Bioinformatics (Proceedings of ISMB 2001), 17:22-29, 2001.
[9] O. Alter, P. O. Brown, and D. Botstein. Singular value decomposition for genome-wide expression data processing and modeling. Proc. Natl. Acad. Sci. USA, 97:10101-10106, 2000.
[10] C. Rosty, I. Tsafrir, N. Stransky, D. Tsafrir, J. P. Thiery, F. Radvanyi, E. Domany, and X. Sastre. Characterization of gene expression profiles in cervical carcinoma submitted to AACR 2004.
[11] D. A. Notterman, U. Alon, A. J. Sierk, and A. J. Levine, Transcriptional gene expression profiles of colorectal adenoma, adenocarminoma, and normal tissue examined by oligonucleotide arrays. Cancer Res., 16:3124-3130-2001.
[12] S. Roweis and L. Saul. Nonlinear dimensionality reduction by locally linear embedding. Science, 290 (5500):2323-2326, 2000.
[13] J. B. Tenenbaum, V. de Silva, and J. C. Langford. A global geometric framework for nonlinear dimensionality reduction. Science, 290(5500) 2319-2323, 2000.
[14] M. R. Garey and D. S. Johnson. Computer & Intractability: A Guide to the Theory of NP-Completeness. W H Freeman, 1979.
[15] C. H. Papadimitriou. The euclidean traveling salesman problem is np-complete. Theoretical Computer Science, 4(3):237-244, 1977.
[16] I. Tsafrir, L. Ein-Dor, O. Zuk, D. Tsafrir, and E. Domany. Iterative sorting algorithm for multidimentional data organization and visualization. in preperation, 2004.
[17]. Rozovskaia, T., Ravid-Amir, O., Tillib, S., Getz, G., Feinstein, E., Agrawal, H., Nagler, A., Rappeport, E. Issaeva, I., Matsuo, Y., Kees, U. R., Lapidot, T., Lo Coco, F., Foa, R., Mazo, A., Nakamura, T., Croce, C. M., Cimino, G., Domany, E. and Canaani, E, PNAS 100, 7853 (2003).
D. Ghosh. Mixture models for assessing differential expression in complex tissues using microarray data. Bioinformatics, 20(11):1663-1669, 2004.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for analyzing data, comprising performing an unsupervised analysis of data according to a reordered distance matrix.

2. The method of claim 1, wherein said distance matrix is reordered using a weighting function.

3. The method of claim 1, suitable for automatically and semi-automatically analyzing data.

4. The method of claim 1, wherein the data comprises a plurality of objects characterized by continuous variables.

5. The method of claim 1, further comprising:
visualization of the data according to said analysis.

6. The method of claim 5, further comprising:
detecting at least one characteristic of the data according to said visualization.

7. The method of claim 1, further comprising:
detecting at least one characteristic of the data according to said analysis.

8. The method of claim 6, wherein the data is analyzed without reference to a predetermined order and/or wherein the data lacks pre-ordering.

9. The method of claim 1, comprising the SPIN method.

10. The method of claim 9, wherein the SPIN method comprises the Side-to-Side (STS) method, featuring a strictly increasing or decreasing vector for reordering said distance matrix.

11. The method of claim 10, wherein said STS method comprises:
Input: D_{n×n} and a strictly increasing vector X
1. Compute S=D X.
2. Sort S in descending order to get S′=P(S), where P is the sorting permutation.
3. If P(S) !=S, set D=P D^{T} and go to stage 1.
4. Output D.

12. The method of claim 11, further comprising performing stages 1-3 more than once.

13. The method of claim 11, further comprising using at least one heuristic to reorder D.

14. The method of claim 9, wherein the SPIN method comprises the Neighborhood method, featuring a matrix of fixed size.

15. The method of claim 14, wherein said Neighborhood method comprises:
Input: D_{n×n} and W_{n×n}
1. Compute M=D W
2. Set P=arg min_{QεS}_{ₙ} tr(QM)
3. If tr (P M) !=tr (M), set D=P D PT and go to 1.
4. Output D.

16. The method of claim 15, further comprising performing stages 1-3 more than once.

17. The method of claim 15, further comprising using at least one heuristic to reorder D.

18. The method of claim 14, wherein the Neighborhood method features Gaussian smoothing.

19. The method of claim 15, wherein stage 2 is performed by solving the Linear Assignment Problem.

20. The method of claim 1, further comprising:
zooming in on a part of the data by separately examining a sub-matrix of the data according to said analysis.

21. The method of claim 20, further comprising:
separately examining a plurality of sub-matrices of the data according to said analysis; and
comparing results of said separate examinations to determine at least one characteristic of the data.

22. The method of claim 1, wherein the data comprises gene expression data and/or data from a gene microarray, comprising data from a large number of genes analyzed simultaneously.

23. The method of claim 1, wherein the data comprises data from expression of genes in cancerous tissue.

24. The method of claim 1, wherein the data comprises data related to a biological process, optionally including a biological cycle.

25. The method of claim 1 adapted for machine vision.

26. A method for analyzing gene expression data and/or data from a gene microarray, comprising data from a large number of genes analyzed simultaneously, comprising:
filtering the data according to a variance filter to form filtered data;
determining a distance matrix for said filtered data; and
reordering said distance matrix to analyze said filtered data.

27. The method of claim 26, further comprising:
analyzing said reordered distance matrix to determine at least one characteristic of said filtered data.

28. The method of claim 27, wherein said reordering is performed according to an automatic and/or semi-automatic, unsupervised analysis.

29. The method of claim 28, wherein said reordering is performed according to SPIN.

30. The method of claim 27, wherein the data is analyzed to determine a noise level in the data.

31. The method of claim 30, wherein said noise level is used to alter at least one characteristic of the microarray or of an experimental protocol for data collection.

32. The method of claim 27, wherein the data is analyzed to determine an inherent property of the data other than a property for which the experiment was designed.

33. The method of claim 26, wherein the data comprises cancer-related data.

34. The method of claim 26, adapted for ordering both samples and genes.

35. A method for analyzing data related to a biological process, optionally including a biological cycle, comprising the SPIN method.

36. A method for machine vision, comprising the SPIN method.

37. The method of claim 36, wherein the SPIN method is performed for analyzing a distance matrix for visual data.

38. The method of claim 37, further comprising:
zooming in on a part of the data by separately examining a sub-matrix of the data according to said analysis.

39. The method of claim 38, further comprising:
separately examining a plurality of sub-matrices of the data according to said analysis; and
comparing results of said separate examinations to determine at least one characteristic of the data.

40. A method according to claim 1, for partitioning the data into a plurality of optionally overlapping subsets.

41. The method of claim 40, further comprising:
using the distance matrices calculated from each subset separately to find novel partitions.

42. The method of claim 1, further comprising implementing the method and presenting the data with an intuitive easy-to-use GUI.

43. A method for analyzing data from expression of genes in cancerous tissue, comprising the SPIN method.

44. The method of claim 1, further comprising optionally constraining said reordering according to a dendrogram from any hierarchical clustering method.
